(19) United States
(12) Patent Application Publication
(10) Pub. No.: US 2022/0274135 A1
(43) Pub. Date: Sep. 1, 2022

(54) VIBRATORY CLASSIFIER DRIVE APPARATUS, SYSTEM AND METHODS

(71) Applicant: Superior Industries, LLC, Morris, MN (US)

(72) Inventors: Lafe Grimm, Hancock, MN (US); Cody Tufford, Lansing, MI (US); Paul Flickinger, Morris, MN (US)

(21) Appl. No.: 17/653,021

(22) Filed: Mar. 1, 2022

Related U.S. Application Data
(60) Provisional application No. 63/154,973, filed on Mar. 1, 2021.
(60) Provisional application No. 63/190,529, filed on May 19, 2021.

(51) Int. Cl. B07B 1/42; B07B 1/28; B07B 1/36

(52) U.S. Cl. CPC B07B 1/42; B07B 1/284; B07B 1/36

(57) ABSTRACT

Vibratory classifier apparatus are provided, e.g., for classification of materials such as wet or dry aggregate materials. In some embodiments a drive system of the classifier includes a spindle with one or more blind holes in a collar thereof. In some embodiments a drive system of the classifier includes a bearing cover having a self-centering portion. In some embodiments a drive system of the classifier includes a spindle an annular portion for receiving a seal.

### BACKGROUND

Vibratory classifiers (such as vibratory horizontal and incline screens and grizzly feeders) use vibration to classify materials such as wet or dry aggregate materials.

### BRIEF DESCRIPTION OF THE DRAWINGS

FIG. 1 is a perspective view of an embodiment of a vibratory screen.

FIG. 2 is a side elevation view of the vibratory screen of FIG. 1.

FIG. 3 is a perspective view of an embodiment of a drive system of the vibratory screen of FIG. 1.

FIG. 4 is an enlarged perspective view of the drive system of FIG. 3 cut away along section A-A of FIG. 2.

FIG. 5 is a sectional view along section A-A of FIG. 2.

FIG. 6 is an enlarged sectional view along section A-A of FIG. 2.

FIG. 7 is a perspective view of an embodiment of a spindle of the drive system of FIG. 3.

FIG. 8 is a front elevation view of the spindle of FIG. 7.

FIG. 9 is a rear elevation view of the spindle of FIG. 7.

FIG. 10 is a sectional view of the spindle of FIG. 1 along the section A-A of FIG. 2.

FIG. 11 is a side elevation view of another embodiment of a vibratory screen with certain components not shown in order to illustrate a lock bolt assembly inside of a housing of the vibratory screen.

FIG. 12 is a sectional view along section E-E of FIG. 11.

### DETAILED DESCRIPTION

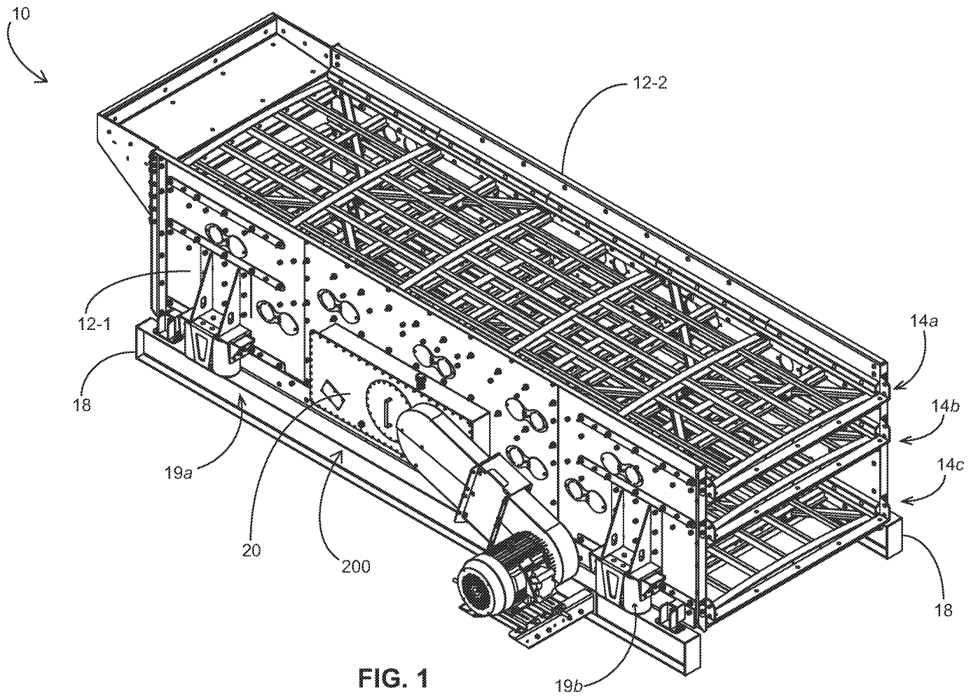

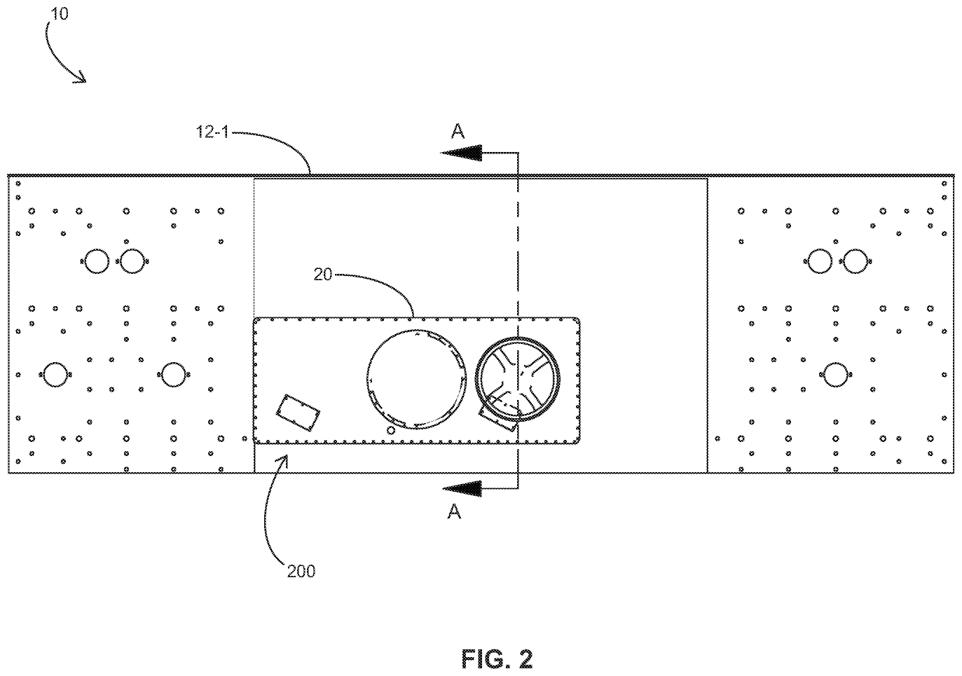

Referring to the drawings, wherein like reference numerals designate identical or corresponding parts throughout the several views, FIGS. 1 and 2 illustrate an embodiment of a vibratory screen 10 for classifying loose material, such as aggregate. The vibratory screen 10 is comprised of a pair of sidewalls 12-1, 12-2 and a plurality of classifying screen decks 14 supported between sidewalls 12. In some embodiments, each of the sidewalls 12 optionally include a pair of spring suspension systems 19a, 19b near each end of the vibratory screen for resiliently supporting the screen on a stationary base 18, which may comprise a dedicated (mobile or stationary) structure as illustrated or an exposed surface such as the ground. In general, vibratory screen 10 optionally includes one embodiment of a support structure 19 with a weight-bearing surface on the sidewall of the vibratory screen in the vicinity of the suspension system 16. A vibratory drive system 200 configured to vibrate the screen 10 is optionally at least partially housed within a housing 20, which housing is optionally mounted on one of the sidewalls 12-1. In some embodiments the housing 20 is at least partially filled with a lubricant.

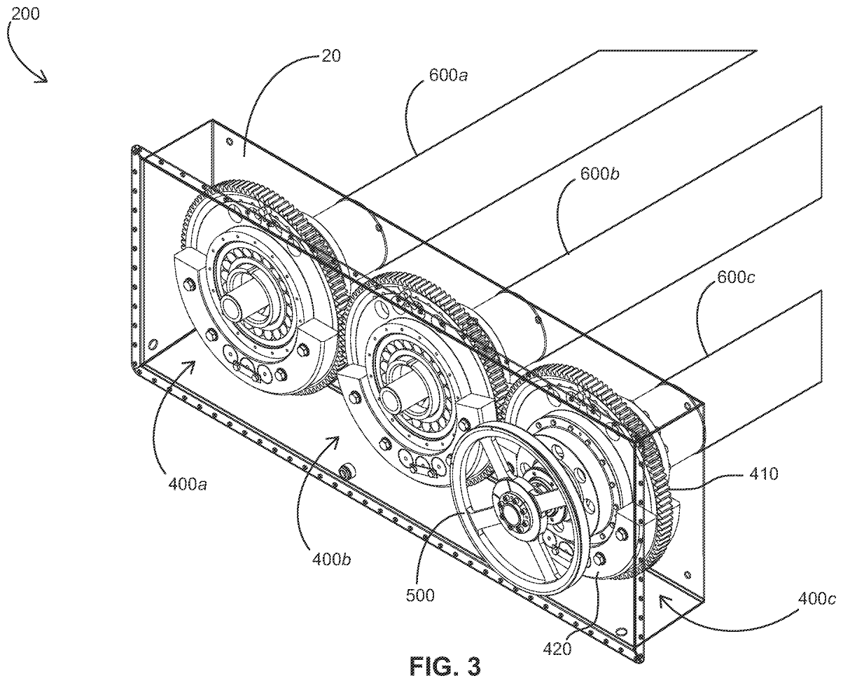

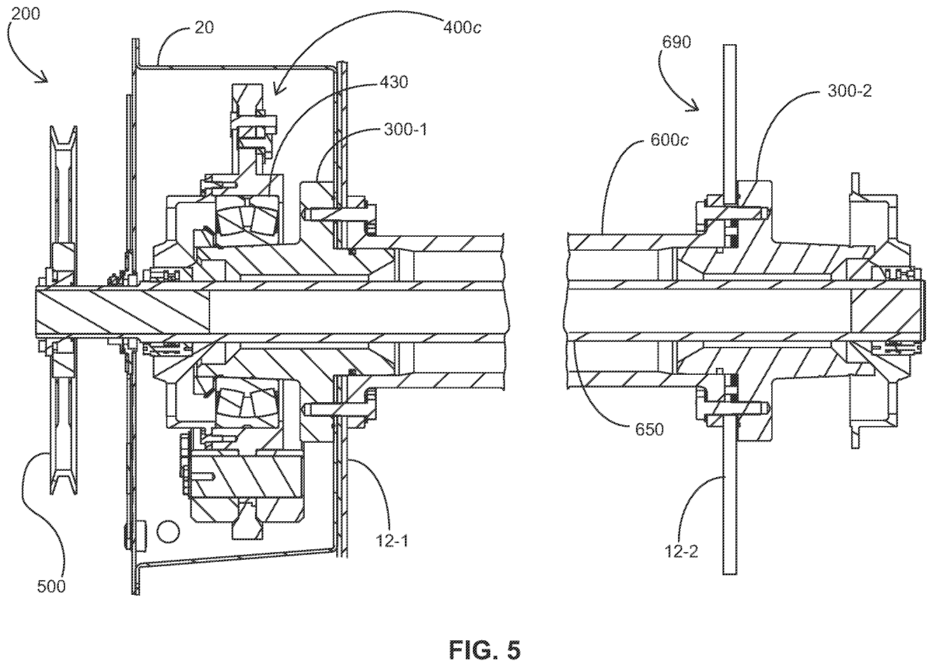

Referring to FIGS. 3 and 5, the vibratory drive system 200 optionally comprises a plurality of eccentric weight assemblies 400 (e.g., 400a, 400b, 400c). Eccentric weight assembly 400c optionally comprises an input sheave 500 by which the weight assembly 400c is driven for rotation (e.g., by a drive belt operably coupled to an electric motor or other drive, not shown). Each eccentric weight assembly 400 optionally comprises a gear 410 operably coupled to a gear 410 of an adjacent eccentric weight assembly, such that rotation of the assembly 400c causes rotation of assemblies 400b and 400a. Each eccentric weight assembly 400 optionally comprises an eccentric weight 420. Rotation of the eccentric weights of the system 200 optionally causes vibration of the screen 10.

Each eccentric weight assembly 400 is optionally disposed inside of the housing 20. Each eccentric weight assembly 400 is optionally supported on a shaft 650. The shaft 650 optionally extends through a rear wall 22 of housing sidewall 12-1, between the sidewalls 12-1 and 12-2, and through sidewall 12-1. The shaft 650 is optionally at least partially surrounded by a housing 600. The shaft 650 is optionally at least partially supported at a first end thereof on a spindle 300-1 which is in turn supported on the sidewall 12-1. The shaft 650 is optionally at least partially supported at a second end thereof on a spindle 300-2 which is in turn supported on the sidewall 12-2.

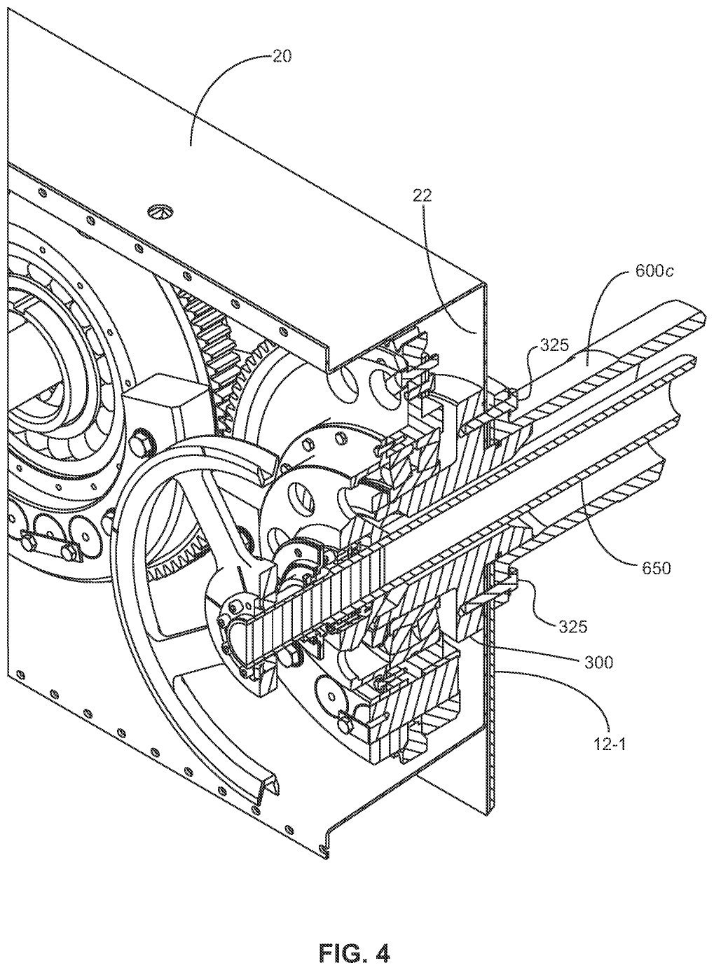

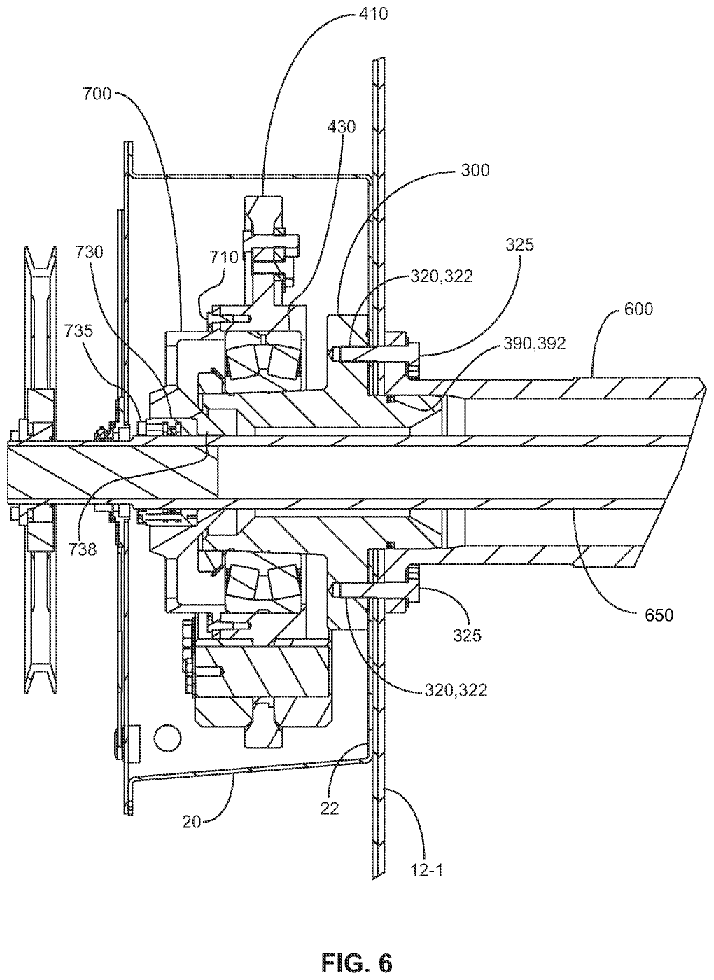

Referring to FIGS. 4 and 6, the spindle 300 is optionally removably mounted to sidewall 12-1 by a plurality of threaded bolts 325 or other fasteners. The spindle 300 optionally includes a plurality of blind holes 320 having threads 322 for receiving the bolts 325. In some embodiments the head of bolt 325 is optionally between the sidewalls 12-1, 12-2 and the blind hole 320 extends into a surface of the spindle 300 facing toward sidewall 12-1, as illustrated. In alternative embodiments the head of bolt 325 is disposed within the housing 20 and the blind hole 320 extends into a surface of the spindle 300 facing away from sidewall 12-1.

The shaft 650 is optionally supported on spindle 300 by a bearing cap 700. Bearing cap 700 is optionally secured to shaft 650 by an expanding annular wedge assembly 730 (which optionally expands to secure the bearing cap to the shaft by tightening a bolt 735) or other structure. The bearing cap 700 optionally includes an annular guide 738 (e.g., clearance fit to an outer diameter of shaft 650) for guiding the bearing cap onto the shaft during installation, e.g., prior to tightening the wedge assembly 730 to secure the bearing cap onto the shaft. The bearing cap 700 is optionally removably fastened to the gear 410 by a plurality of bolts 710 or other fasteners. The gear 410 is optionally pivotally supported on the spindle 300 by a bearing assembly 430.

Referring to FIG. 6, the spindle 300 optionally includes an annular channel 390 for receiving an annular sealing element 392. In an installed position of spindle 300, the channel 390 and sealing element 392 are disposed inside of housing 600 and between sidewalls 12-1, 12-2.

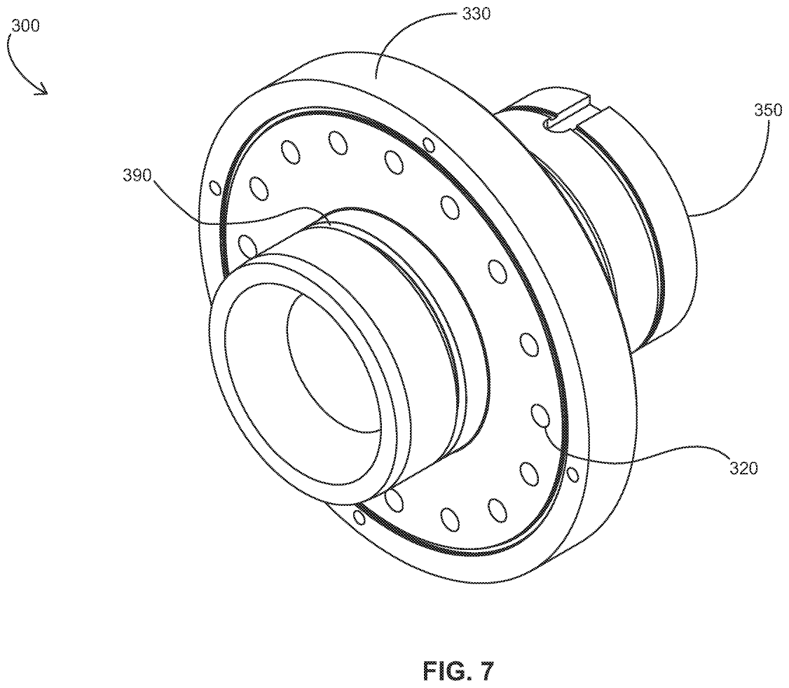

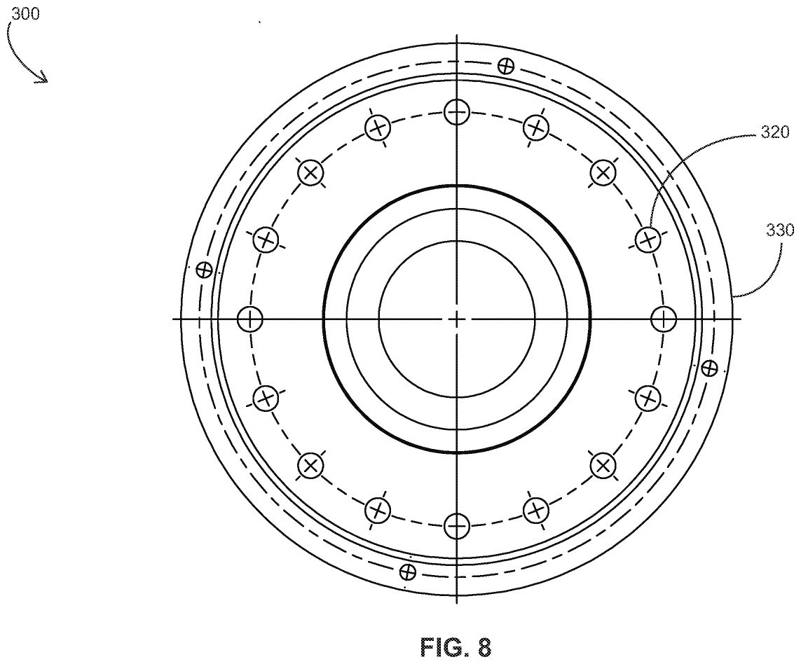

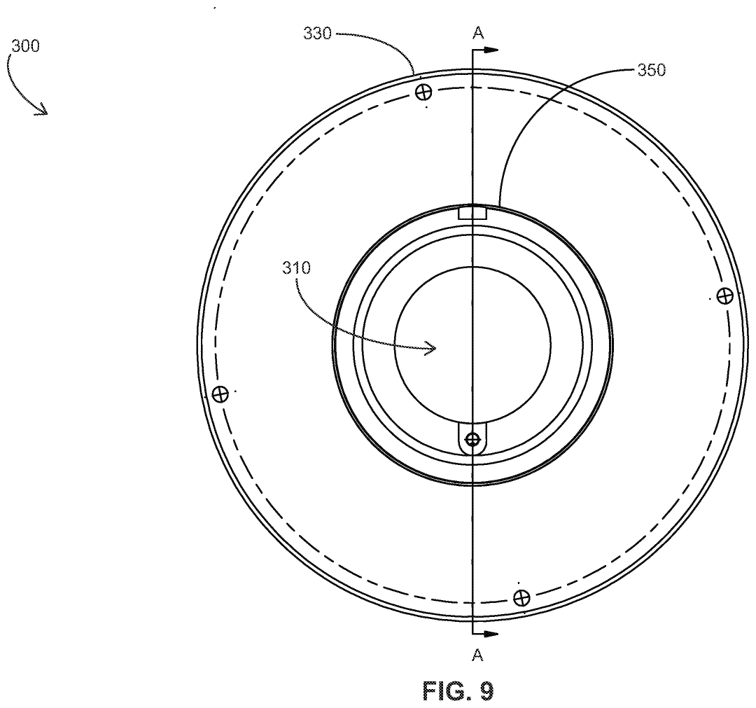

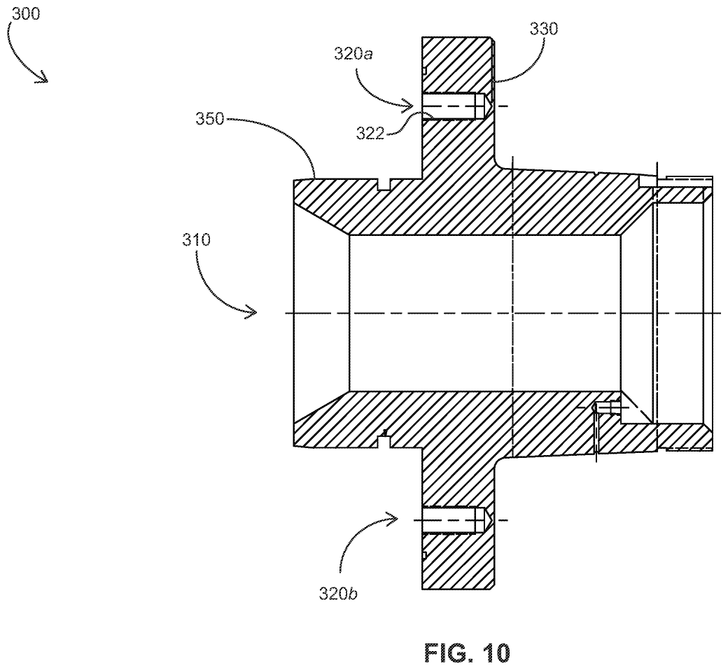

Referring to FIGS. 7-10, the spindle 300 optionally includes a cylindrical body 350 with a radially extending collar 330. The plurality of blind holes 320 are optionally disposed and radially arranged in the collar 330.

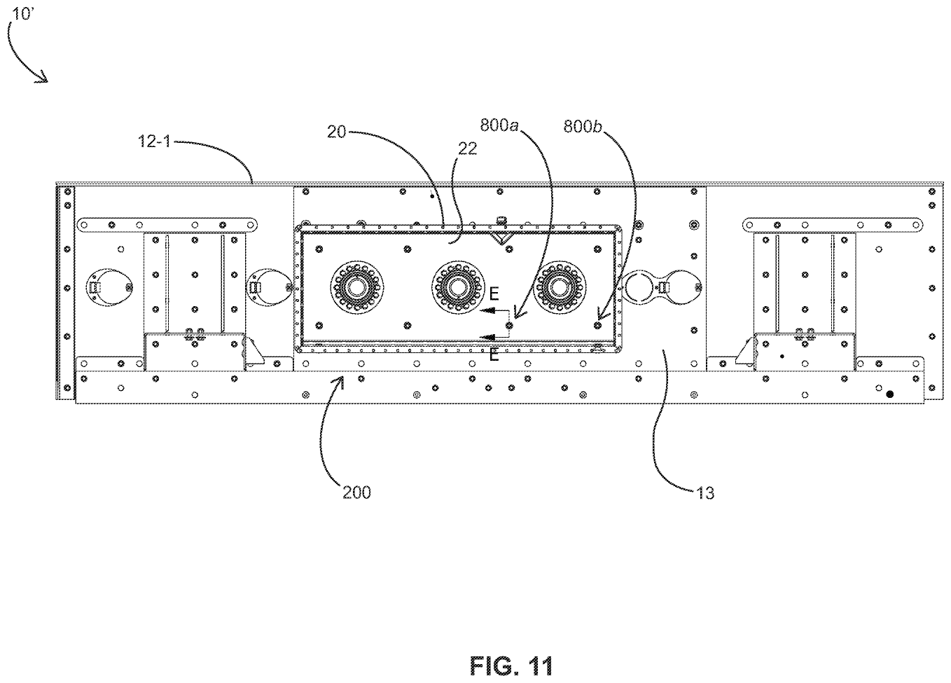

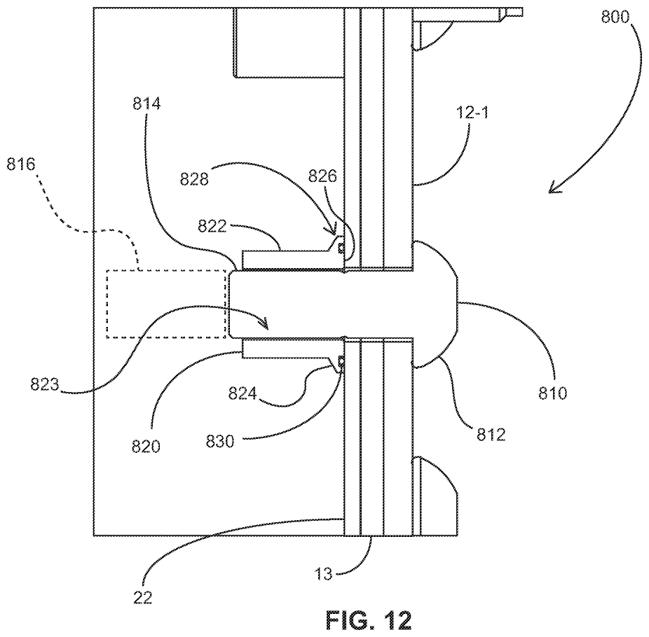

Referring to FIGS. 11-12, an embodiment of a vibratory screen 10′ is illustrated comprising at least one lock bolt assembly 800 (e.g., a plurality of assemblies 800a, 800b, etc.) which optionally secures the housing 20 (e.g., the rear wall 22 thereof) to the sidewall 12-1.

Referring to FIG. 12, the lock bolt assembly 800 optionally comprises a lock bolt 810, a collar 820, and a sealing element 830 (e.g., an annular sealing element, such as an o-ring, which may be made of any suitable material such as rubber, polytetrafluoroethylene (PTFE), nitrile, neoprene, fluorocarbon, etc.). The lock bolt assembly 800 optionally has one or more common features or functionality with one or more embodiments disclosed in U.S. Pat. No. 8,621,734, incorporated herein by reference.

Continuing to refer to FIG. 12, the bolt 810 optionally comprises a head 812 and a threaded pin 814 connected to (e.g., formed as a part with) the head 812. After installation, a removable portion 816 of the pin is optionally separated from the pin 814. The collar 820 optionally comprises a collar body 822 having an axial opening 823 therethrough. The pin 814 optionally extends through and is optionally coupled to the axial opening 823. The collar 820 optionally comprises a collar flange 824 connected to (e.g., formed as a part with) The collar body 822. The collar flange 824 optionally comprises an annular face 826 having an annular groove 828 formed therein. The sealing element 830 is optionally disposed at least partially within the annular groove 828.

The lock bolt assembly 800 is optionally installed to secure the housing 20 in position relative to the sidewall 12-1 (e.g., with the rear wall 22 against the sidewall 12-1 or against a reinforcing plate 13 disposed against the sidewall 12-1, etc.). In some embodiments, the pin 814 extends through the sidewall 12-1 and the rear wall 22 of the housing 20. In some embodiments, the collar 820 is secured against the rear wall 822. In some embodiments, the sealing element 830 is secured between the collar 820 and the rear wall 22, e.g., in order to prevent fluid such as lubricant from escaping the housing 20 around the bolt 810.

In some embodiments, the lock bolt assembly comprises or is replaced with a structural rivet assembly or other assembly which is optionally configured to prevent relative movement of the assembly components under vibration.

Although specific embodiments have been illustrated and described, it will be appreciated by those of ordinary skill in the art that a variety of alternate and/or equivalent implementations may be substituted for the specific embodiments shown and described without departing from the scope of the disclosure. This application is intended to cover any adaptations or variations of the specific embodiments of the support structures described herein. Therefore, it is intended that the specification is exemplary in nature, and that the scope of the invention is solely defined by the claims the equivalents thereof. For example, any feature described for one embodiment may be used in any other embodiment.

What is claimed is:

1. A vibratory screen, comprising:
first and second sidewalls;
at least a first classifying deck supported between said first and second sidewalls;
a plurality of eccentric weights disposed outside of said first and second sidewalls;
a housing configured to contain a quantity of lubricant, said housing enclosing at least a portion of said plurality of eccentric weights, said housing having a rear wall disposed adjacent to said first sidewall; and
a lock bolt assembly securing said housing to said first sidewall, said lock bolt assembly comprising:
a collar having an axial opening and an annular face, said annular face engaging said rear wall of said housing, wherein said annular face includes an annular groove;
an annular sealing element disposed in said annular groove; and
a pin extending through said annular groove, said pin having a head disposed outside of said axial opening.

2. The vibratory screen of claim 1, wherein said annular sealing element comprises an o-ring.

3. The vibratory screen of claim 2, wherein said annular sealing element comprises one of rubber, polytetrafluoroethylene, nitrile, neoprene, and fluorocarbon.

4. The vibratory screen of claim 1, wherein said pin comprises a removable portion.

5. The vibratory screen of claim 1, wherein said pin is coupled to said axial opening.

6. The vibratory screen of claim 1, wherein said collar comprises a collar body and a collar flange.

7. The vibratory screen of claim 1, wherein said annular groove is formed in said collar flange.

8. The vibratory screen of claim 1, in which said pin extends through said sidewall and said rear wall.

9. The vibratory screen of claim 1, wherein said collar is secured against said rear wall.

10. The vibratory screen of claim 1, wherein said annular sealing element is secured between said collar and said rear wall to prevent said quantity of lubricant from escaping said housing.

11. A lock bolt assembly for use with a vibratory screen having first and second sidewalls and a housing configured to contain a quantity of lubricant, the housing enclosing at least a portion of a plurality of eccentric weights, the housing having a rear wall disposed adjacent to the first sidewall, said lock bolt assembly comprising:
a collar having an axial opening and an annular face, said annular face engaging the rear wall of the housing, wherein said annular face includes an annular groove;
an annular sealing element disposed in said annular groove; and
a pin extending through said annular groove, said pin having a head disposed outside of said axial opening, wherein said collar and said pin cooperatively secure the housing to the first sidewall.

12. The lock bolt assembly of claim 11, wherein said annular sealing element comprises an o-ring.

13. The lock bolt assembly of claim 12, wherein said annular sealing element comprises one of rubber, polytetrafluoroethylene, nitrile, neoprene, and fluorocarbon.

14. The lock bolt assembly of claim 11, wherein said pin comprises a removable portion.

15. The lock bolt assembly of claim 11, wherein said pin is coupled to said axial opening.

16. The lock bolt assembly of claim 11, wherein said collar comprises a collar body and a collar flange.

17. The lock bolt assembly of claim 11, wherein said annular groove is formed in said collar flange.

18. The lock bolt assembly of claim 11, in which said pin is configured to extend through the sidewall and the rear wall.

19. The lock bolt assembly of claim 11, wherein said collar configured to be secured against the rear wall.

20. The lock bolt assembly of claim 11, wherein said annular sealing element is configured to be secured between said collar and the rear wall to prevent the quantity of lubricant from escaping the housing.
